(19) United States
(12) Patent Application Publication
(10) Pub. No.: US 2026/0059082 A1
(43) Pub. Date: Feb. 26, 2026

(54) PROJECTOR AND AUTOFOCUS METHOD

(71) Applicant: Coretronic Corporation, Hsin-Chu (TW)

(72) Inventors: Chih-Chen Chen, Hsin-Chu (TW); Hao-Tien Yao, Hsin-Chu (TW)

(73) Assignee: Coretronic Corporation, Hsin-Chu (TW)

(21) Appl. No.: 19/309,623

(22) Filed: Aug. 26, 2025

(30) Foreign Application Priority Data
Aug. 26, 2024 (CN) 202411173265.1

(51) Int. Cl. H04N 9/31

(52) U.S. Cl. CPC H04N 9/3185; H04N 9/317; H04N 9/3194

(57) ABSTRACT

A projector and an autofocus method are provided. The projector includes a ranging unit, an inertial sensor, a control module, and a lens module. The lens module includes a projection lens and a focusing motor. When the projector is in a first mode, the control module compares an inertial sensing signal with an activation threshold to generate a first comparison result, and determines accordingly whether to switch the projector from the first mode to a second mode. When the projector is in the second mode, the ranging unit continuously detects a distance between the projector and a projection surface to generate a distance signal, and the control module generates a corresponding focusing signal to the focusing motor according to the distance signal so as to drive the focusing motor to adjust a focal length of the projection lens according to the focusing signal.

### CROSS-REFERENCE TO RELATED APPLICATION

This application claims the priority benefit of China application serial no. 202411173265.1, filed on Aug. 26, 2024. The entirety of the above-mentioned patent application is hereby incorporated by reference herein and made a part of this specification.

### BACKGROUND

### Technical Field

The disclosure relates to a projector, and particularly relates to an autofocus method and a projector using an inertial sensor and a ranging unit.

### Description of Related Art

In the current technology, the autofocus function of a projector often faces many challenges. When a user moves the projector, the projector needs to recalculate its distance from the screen to ensure that the projected image may be displayed clearly. However, this process usually takes a relatively long time, causing the projected image to appear blurry for a short period, which not only affects a viewing experience of the user, but also reduces the practicality of the projector. For example, in some conventional autofocus systems, the projector relies on built-in distance sensors to measure the distance between the projector and the screen. Once the projector is moved, the sensors need to remeasure the distance and adjust the focal length of the lens based on the new distance data. Since the measurement and adjustment process requires a certain amount of time, the user often has to wait several seconds or longer to obtain a clear projected image after repositioning the projector.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the disclosure provides a projector including: a ranging unit, an inertial sensor, a control module, and a lens module. The inertial sensor is configured to continuously detect a motion state of the projector to generate an inertial sensing signal. The control module includes a processor. The processor is electrically connected to the ranging unit and the inertial sensor, and is configured to receive the inertial sensing signal. The lens module includes a projection lens and a focusing motor. The projection lens is configured to project an image beam onto a projection surface. The focusing motor is electrically connected to the control module to adjust a focal length of the projection lens. When the projector is in a first mode, the processor compares the inertial sensing signal with an activation threshold to generate a first comparison result, and determines, according to the first comparison result, whether to switch the projector from the first mode to a second mode. When the projector is in the second mode, the ranging unit continuously detects a distance between the projector and the projection surface to generate a distance signal, and continuously outputs the distance signal to the processor. The processor generates a corresponding focusing signal to the focusing motor of the lens module according to the distance signal so as to drive the focusing motor to adjust the focal length of the projection lens according to the focusing signal.

An embodiment of the disclosure further provides an autofocus method for a projector. The projector includes a lens module. The lens module includes a projection lens and a focusing motor. The projection lens is configured to project an image beam onto a projection surface. The autofocus method includes: continuously detecting a motion state of the projector through an inertial sensor to generate an inertial sensing signal; in a first mode, comparing the inertial sensing signal with an activation threshold to generate a first comparison result, and determining whether to switch the projector from the first mode to a second mode according to the first comparison result; and in a second mode, continuously detecting a distance between the projector and the projection surface through a ranging unit to generate a distance signal, and continuously outputting the distance signal, and generating a corresponding focusing signal to the focusing motor of the lens module according to the distance signal so as to drive the focusing motor to adjust a focal length of the projection lens.

To make the aforementioned more comprehensible, several embodiments accompanied with drawings are described in detail as follows.

### BRIEF DESCRIPTION OF THE DRAWINGS

FIG. 1 is a schematic diagram of a projector according to an embodiment of the disclosure.

FIG. 2 is a flowchart illustrating an autofocus method according to an embodiment of the disclosure.

FIG. 3 and FIG. 4 are schematic diagrams illustrating a precise focusing procedure according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “left,” “right,” “front,” “back,” etc., is used with reference to the orientation of the Figure(s) being described and are not intended to be limiting of the disclosure.

Some embodiments of the disclosure will be described in detail with reference to the accompanying drawings. The component symbols cited in the following description will be regarded as the same or similar components when the same component symbols appear in different drawings. These embodiments are only part of the disclosure and do not disclose all possible implementations of the disclosure. Rather, these embodiments are merely examples of systems and methods within the scope of the disclosure.

The disclosure provides a projector and an autofocus method, which may provide clear images when the projector is in motion (including movement and/or rotation), and may also increase a focusing speed.

Additional aspects and advantages of the present disclosure will be set forth in the description of the techniques disclosed in the present disclosure.

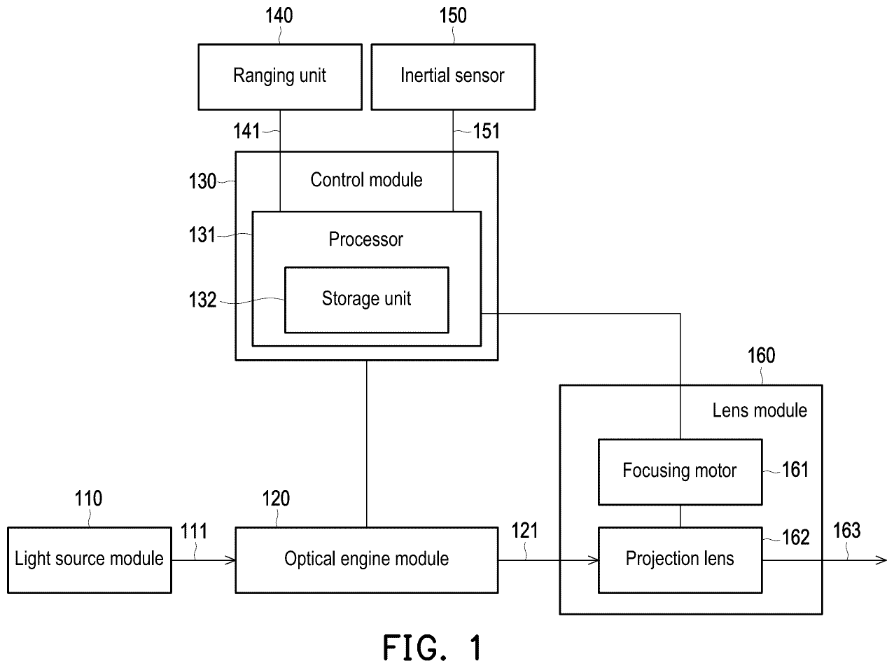

FIG. 1 is a schematic diagram of a projector according to an embodiment of the disclosure. Referring to FIG. 1, a projector 100 includes a light source module 110, an optical engine module 120, a control module 130, a ranging unit 140, an inertial sensor 150, and a lens module 160. The control module 130 includes a processor 131, and the processor 131 includes a storage unit 132. The processor 131 is electrically connected to the ranging unit 140 and the inertial sensor 150. The lens module 160 includes a focusing motor 161 and a projection lens 162 connected to each other. The control module 130 is also electrically connected to the focusing motor 161 and the optical engine module 120.

The light source module 110 includes any device capable of providing a light source, and is configured to provide an illumination beam 111 to the optical engine module 120. For example, the light source module 110 may include a laser light source, a solid-state light source, a halogen lamp, a light-emitting diode, a laser diode, a xenon lamp, a high-pressure mercury lamp, and the like, but the disclosure is not limited thereto.

The optical engine module 120 is configured to receive the illumination beam 111 from the light source module 110 and output an image beam 121 to the lens module 160. The optical engine module 120 may include a digital micromirror device (DMD), a liquid crystal display (LCD), a liquid crystal on silicon (LCoS) panel, a digital light processing (DLP) unit, and the like, but the disclosure is not limited thereto.

The ranging unit 140 may include a time-of-flight (TOF) unit, an ultrasonic unit, a stereoscopic image unit, a structured light unit, and the like, and is configured to detect a distance between a projection surface and the projector 100 to generate a distance signal 141, and transmit the distance signal 141 to the processor 131 of the control module 130.

The inertial sensor 150 may include an acceleration sensor, an angular velocity sensor, a magnetometer, and the like, and is configured to continuously detect a motion state of the projector 100 to generate an inertial sensing signal 151, and transmit the inertial sensing signal 151 to the processor 131 of the control module 130. For example, the motion state may include movement and/or rotation of the projector 100. The inertial sensing signal 151 may include information of the projector 100 in various directions such as acceleration, velocity, angular acceleration, angular velocity, direction, and the like.

The focusing motor 161 is configured to adjust a focal length of the projection lens 162. The focusing motor 161 may be, for example, a stepper motor, a DC servo motor, a brushless DC motor, or the like, but the disclosure is not limited thereto. The projection lens 162 is configured to project an image beam 163 onto the projection surface. The projection lens 162 may include one or more optical lenses, and the focal length of the projection lens 162 may be changed by moving the position of the optical lenses via the focusing motor 161. The refractive powers of the plurality of optical lenses may be the same as or different from each other. For example, the optical lenses may include various non-planar lenses such as biconcave lenses, biconvex lenses, concavo-convex lenses, convexo-concave lenses, plano-convex lenses, plano-concave lenses, or any combination thereof. On the other hand, the projection lens 162 may also include planar optical lenses. The disclosure does not limit the specific structure of the projection lens 162.

The control module 130 controls the optical engine module 120 to convert the illumination beam 111 into the image beam 121, and the image beam 121 passes through the projection lens 162 to generate the image beam 163. At the same time, the control module 130 also controls the focusing motor 161 to adjust the focal length and diopter of the projection lens 162, so that the image beam 163 is projected and focused on the projection surface.

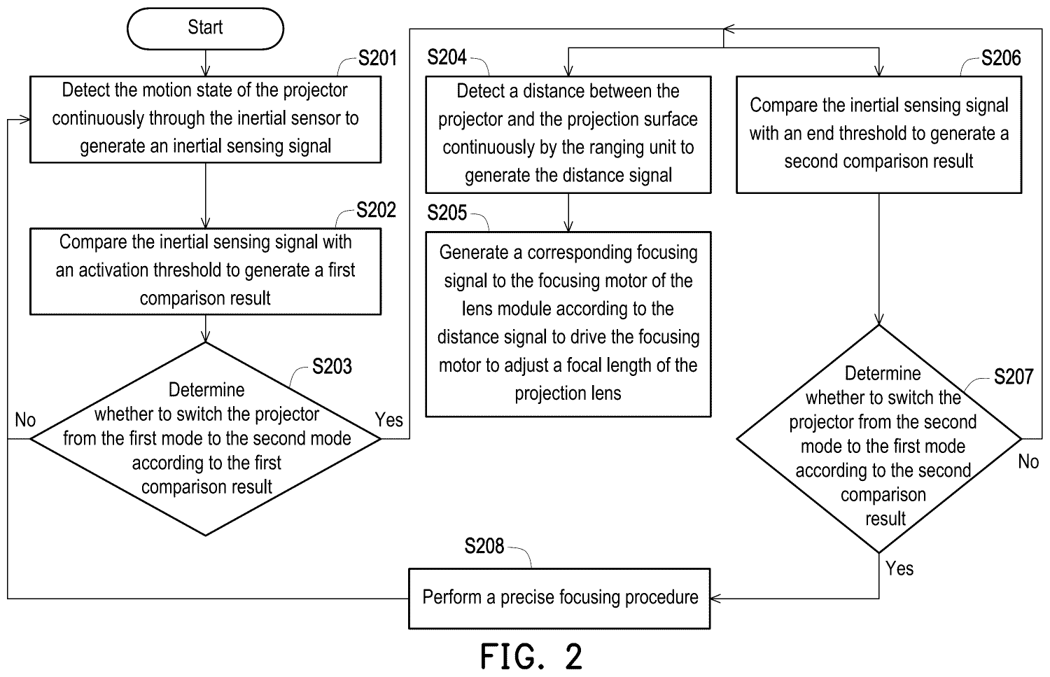

In this embodiment, the processor 131 determines an operating mode of the projector 100 according to the inertial sensing signal 151, such as a first mode or a second mode. Generally, the first mode is applicable when the projector 100 is in a stationary state and the image beam 163 is projected, while the second mode is applicable when the projector 100 is in a motion state and the image beam 163 is projected. In either mode, the projector 100 may project the image beam 163 to form a clear image on the projection surface. FIG. 2 is a flowchart illustrating an autofocus method according to an embodiment of the disclosure. Referring to FIG. 1 and FIG. 2, FIG. 2 shows steps S201-S208, where steps S201-S203 belong to operations of the projector 100 in the first mode, and steps S204-S208 belong to operations of the projector 100 in the second mode.

In step S201, the motion state of the projector 100 is continuously detected through the inertial sensor 150 to generate an inertial sensing signal 151.

In step S202, the processor 131 compares the inertial sensing signal 151 with an activation threshold to generate a first comparison result. For example, the inertial sensing signal 151 may contain acceleration information. Since acceleration has positive and negative values, an absolute value thereof may be calculated first. Step S202 is used to determine whether the acceleration (through calculation of the absolute value) in the inertial sensing signal 151 is greater than or equal to the activation threshold so as to generate the first comparison result. Alternatively, the inertial sensing signal 151 may also include angular acceleration information. In this case, step S202 may determine whether the angular acceleration (through calculation of the absolute value) in the inertial sensing signal 151 is greater than or equal to the activation threshold so as to generate the first comparison result.

In step S203, it is determined whether to switch the projector 100 from the first mode to the second mode according to the first comparison result. In some embodiments, when the first comparison result is that the inertial sensing signal 151 is greater than or equal to the activation threshold, the processor 131 determines to switch the projector 100 from the first mode to the second mode; and when the first comparison result is that the inertial sensing signal 151 is less than the activation threshold, the processor 131 determines to maintain the projector 100 in the first mode. As mentioned above, the inertial sensing signal 151 may include acceleration or angular acceleration information. When the acceleration or angular acceleration (in absolute value) is greater than or equal to the activation threshold, it indicates that the projector 100 is being moved and/or rotated (i.e., in a motion state). Accordingly, the processor 131 determines, according to the first comparison result, to switch the projector 100 to the second mode. Conversely, if the acceleration or angular acceleration (in absolute value) is less than the activation threshold, it indicates that the projector 100 is in a stationary state, or only slightly moving without affecting projection quality. In this case, the processor 131 determines, according to the first comparison result, to maintain the projector 100 in the first mode. Furthermore, in step S203, if the determination result of the processor 131 is No, the process returns to step S201 to continue obtaining the inertial sensing signal 151 through the inertial sensor 150, and repeats steps S202 and S203.

If the determination result of the processor 131 in step S203 is Yes, the projector 100 is switched from the first mode to the second mode. At this time, the processor 131 outputs an actuation signal corresponding to the second mode to the ranging unit 140, causing the ranging unit 140 to start operating to continuously generate the distance signal 141. In other words, the ranging unit 140 does not operate when the projector 100 is in the first mode, but operates to generate the distance signal 141 when the projector 100 is in the second mode. In step S204, the ranging unit 140 continuously detects a distance between the projector 100 and the projection surface to generate the distance signal 141, and continuously outputs the distance signal 141 to the processor 131. It should be noted that in the second mode, the projector 100 may be continuously moved by the user and remain in the motion state, such that the position of the projector 100 keeps changing, and the distance between the projection surface and the projector 100 also keeps changing. Since the ranging unit 140 continuously generates the distance signal 141, the distance signal 141 continuously reflects the current distance between the projection surface and the projector 100.

In step S205, the processor 131 generates a corresponding focusing signal to the focusing motor 161 of the lens module 160 according to the received distance signal 141 so as to drive the focusing motor 161 to adjust a focal length of the projection lens 162. Accordingly, in the second mode, the focal length of the projection lens 162 varies with the distance signal 141. Generally, the greater the distance between the projection surface and the projector 100 (also referred to as the projection distance), the greater the focal length required for the projection lens 162. On the other hand, in the embodiment where the focusing motor 161 is a stepper motor, the focal length of the projection lens 162 may be determined by controlling the step number of the focusing motor 161. In some embodiments, the storage unit 132 in the processor 131 stores a lookup table that records corresponding relationships between the distance signal 141 and the step number of the focusing motor 161, and these corresponding relationships may be obtained through calibration during production of the projector 100. For example, for a projector 100 of a certain model or production line, when the projection distance is 1 meter, the projected image is clearest when the step number of the focusing motor 161 is 100; and when the projection distance is 1.5 meters, the projected image is clearest when the step number of the focusing motor 161 is 120. These projection distances and the corresponding step numbers of the focusing motor 161 are recorded in the lookup table. The processor 131 may obtain a target step number according to the currently received distance signal 141 and the lookup table. Specifically, the focusing signal generated by the processor 131 includes the target step number, and when the focusing motor 161 receives the focusing signal, it adjusts its rotor position to the target step number.

At the same time, in step S206, the processor 131 compares the inertial sensing signal 151 with an end threshold to generate a second comparison result. It should be noted that regardless of whether the projector 100 is in the first mode or the second mode, the inertial sensor 150 continuously operates to detect the motion state of the projector 100 to generate the inertial sensing signal 151. Since the inertial sensing signal 151 is continuously obtained, the second comparison result is used to determine whether the projector 100 is currently stationary and not in motion.

In step S207, the processor 131 determines whether to switch the projector 100 from the second mode to the first mode according to the second comparison result. Specifically, when the second comparison result is that the inertial sensing signal 151 is greater than the end threshold, the processor 131 determines to maintain the projector 100 in the second mode. On the other hand, when the second comparison result is that the inertial sensing signal 151 is less than or equal to the end threshold, the processor 131 determines to switch the projector 100 from the second mode to the first mode. As described above, the inertial sensing signal 151 may include acceleration or angular acceleration information. When the acceleration or angular acceleration (in absolute value) is greater than the end threshold, it indicates that the projector 100 is still in the motion state of moving and/or rotating. Accordingly, the processor 131 determines, based on the second comparison result, to maintain the projector 100 in the second mode (the determination result in step S207 is No), and the process returns to steps S204 and S206 and repeatedly executes steps S205 and S207. If the acceleration or angular acceleration (in absolute value) is less than or equal to the end threshold, it indicates that the projector 100 is stationary. Accordingly, the processor 131 determines, based on the second comparison result, to switch the projector 100 back to the first mode (the determination result in step S207 is Yes).

In some embodiments, the above-mentioned end threshold is different from the activation threshold. For example, the end threshold may be smaller than the activation threshold, such that when the projector 100 is in the first mode, it requires a relatively large amplitude of movement or rotation to be switched to the second mode. Meanwhile, when the projector 100 is in the second mode, it is switched back to the first mode only when it is relatively close to the stationary state. This approach can prevent the processor 131 from mistakenly switching and can also prevent the projector 100 from repeatedly switching modes during slight movements.

When the projector 100 is in the second mode, steps S204-S207 are repeatedly executed. Since the processor 131 continuously obtains the distance signal 141 through the ranging unit 140 and adjusts the focal length of the projection lens 162 accordingly, the focal length of the projection lens 162 is adjusted in real time to prevent the user from seeing an excessively blurred image on the projection surface.

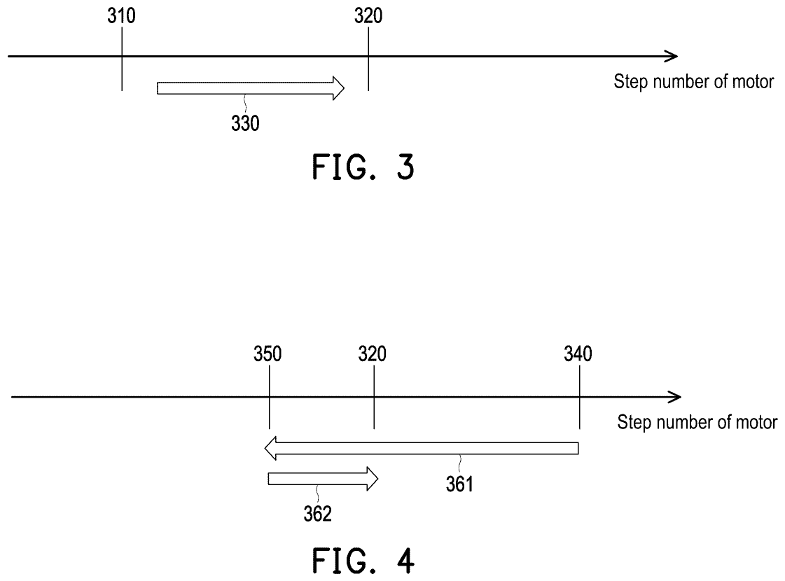

When the determination result of the processor 131 in step S207 is Yes, before the projector 100 is switched from the second mode to the first mode, the process first enters step S208. In step S208, the processor 131 drives the lens module 160 to perform a precise focusing procedure. FIG. 3 and FIG. 4 are schematic diagrams illustrating a precise focusing procedure according to an embodiment of the disclosure. Referring to FIG. 3 and FIG. 4, in the precise focusing procedure, the processor 131 obtains the current distance signal 141 and determines an adjustment direction and a target step number of the focusing motor 161 according to the obtained distance signal 141. As mentioned above, the target step number of the focusing motor 161 corresponding to the current projection distance may be determined according to the distance signal 141 and the lookup table. Generally, the focusing motor 161 has two adjustment directions, one being used to increase the focal length of the projection lens 162, and the other being used to decrease the focal length of the projection lens 162. In FIG. 3, the left-to-right direction is used to increase the focal length of the projection lens 162. For example, the target step number 320 corresponding to the current projection distance is found through the lookup table, and the current step number of the focusing motor 161 is referred to as the current step number 310. An adjustment direction 330 of the focusing motor 161 may be determined according to the target step number 320 and the current step number 310, which in this example is to the right, i.e., to increase the focal length of the projection lens 162.

The focusing motor 161 has a preset direction. When the focusing motor 161 rotates in the preset direction, the adjustment of the focal length of the projection lens 162 is accurate. However, when the focusing motor 161 rotates in a direction opposite to the preset direction, slight errors may occur due to backlash. The backlash of the focusing motor 161 may result from various causes, including gaps between gears or threads, or clearances in bearings, etc. It is assumed here that the preset direction is from left to right.

When the adjustment direction 330 of the focusing motor 161 conforms to the preset direction, the processor 131 generates a focusing signal according to the target step number 320 to control the focusing motor 161 to adjust from the current step number 310 to the target step number 320.

When the adjustment direction of the focusing motor 161 does not conform to the preset direction (for example, in the case of FIG. 4, where the current step number 340 is on the right side of the target step number 320), the step number of the focusing motor 161 must first be adjusted past the target step number 320 and then return to the target step number 320 so as to reduce backlash error. Specifically, the processor 131 sets a correction step number 350, which is on the left side of the target step number 320, such that the distance between the correction step number 350 and the current step number 340 is greater than the distance between the target step number 320 and the current step number 340. In some embodiments, the processor 131 calculates the correction step number 350 according to a backlash value of the focusing motor 161. The backlash value may be converted into a step difference of the motor, and by adding (or subtracting) this step difference to the target step number 320, the correction step number 350 may be obtained. The step difference may be calculated by the processor 131, or may be determined during manufacture of the focusing motor 161 through detection and statistical methods. This step difference may be stored in the storage unit 132 for access by the processor 131.

The processor 131 generates a focusing signal according to the target step number 320 and the correction step number 350 to control the focusing motor 161 to adjust from the current step number 340 to the correction step number 350 according to the adjustment direction 361, and then to adjust from the correction step number 350 to the target step number 320 according to the preset direction 362. In this way, errors caused by backlash can be eliminated.

Referring to FIG. 2 and FIG. 4, since in step S205 the focal length of the projection lens 162 has already been adjusted according to the current distance signal, the distance between the current step number 340 and the target step number 320 is relatively small. In the prior art, the projector 100 adjusted the focal length only after it became completely stationary, so that a larger number of motor steps had to be adjusted, resulting in more time consumption. In contrast, in this embodiment, the focusing motor 161 can be adjusted to the target step number 320 more quickly.

After executing step S208, the processor 131 outputs a termination signal corresponding to the second mode to the ranging unit 140, so that the ranging unit 140 stops detecting the distance between the projection surface and the projector 100, and the projector 100 is switched to the first mode to return to step S201.

Referring to FIG. 1, in some embodiments, the projector 100 may further include another processor (not shown) configured to transmit an autofocus signal to the processor 131, such that the projector 100 can initiate the steps of the autofocus method shown in FIG. 2 to switch between the first mode and the second mode. If the autofocus signal is not received, the processor 131 may refrain from performing autofocus, or may execute an autofocus method different from that shown in FIG. 2.

In summary, the projector and the autofocus method according to the embodiments of the disclosure provide at least one of the following advantages. When the projector is in the motion state of moving and/or rotating, the processor continuously obtains the distance signal and adjusts the focal length of the projection lens accordingly. In this way, when the projector is moved, the user does not see blurry or out-of-focus images on the projection surface. In addition, when the projector is stationary, the focal length can be quickly adjusted to the correct position, thereby enhancing the user experience.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents. Moreover, any embodiment of or the claims of the disclosure is unnecessary to implement all advantages or features disclosed by the disclosure. Moreover, the abstract and the name of the disclosure are only used to assist patent searching. Moreover, “first”, “second”, etc. mentioned in the specification and the claims are merely used to name the elements and should not be regarded as limiting the upper or lower bound of the number of the components/devices.

What is claimed is:

1. A projector, comprising a ranging unit, an inertial sensor, a control module, and a lens module, wherein
the inertial sensor is configured to continuously detect a motion state of the projector to generate an inertial sensing signal,
the control module comprises a processor, the processor is electrically connected to the ranging unit and the inertial sensor, and is configured to receive the inertial sensing signal; and
the lens module comprises a projection lens and a focusing motor, the projection lens is configured to project an image beam onto a projection surface, and the focusing motor is electrically connected to the control module to adjust a focal length of the projection lens,
wherein, when the projector is in a first mode, the processor compares the inertial sensing signal with an activation threshold to generate a first comparison result, and determines, according to the first comparison result, whether to switch the projector from the first mode to a second mode;
when the projector is in the second mode, the ranging unit continuously detects a distance between the projector and the projection surface to generate a distance signal, and continuously outputs the distance signal to the processor, the processor generates a corresponding focusing signal to the focusing motor of the lens module according to the distance signal so as to drive the focusing motor to adjust the focal length of the projection lens according to the focusing signal.

2. The projector as claimed in claim 1, wherein when the projector is in the first mode and the first comparison result is that the inertial sensing signal is greater than or equal to the activation threshold, the processor determines to switch the projector from the first mode to the second mode, and when the first comparison result is that the inertial sensing signal is less than the activation threshold, the processor determines to maintain the projector in the first mode.

3. The projector as claimed in claim 1, wherein when the processor determines, according to the first comparison result, to switch the projector from the first mode to the second mode, the processor outputs an actuation signal corresponding to the second mode to the ranging unit so as to enable the ranging unit to continuously generate the distance signal.

4. The projector as claimed in claim 1, wherein when the projector is in the second mode, the processor compares the inertial sensing signal with an end threshold to generate a second comparison result, and determines, according to the second comparison result, whether to switch the projector from the second mode to the first mode, wherein the end threshold is different from the activation threshold.

5. The projector as claimed in claim 4, wherein the end threshold is less than the activation threshold.

6. The projector as claimed in claim 4, wherein when the second comparison result is that the inertial sensing signal is greater than the end threshold, the processor determines to maintain the projector in the second mode, and when the second comparison result is that the inertial sensing signal is less than or equal to the end threshold, the processor determines to switch the projector from the second mode to the first mode.

7. The projector as claimed in claim 6, wherein when the second comparison result is that the inertial sensing signal is less than or equal to the end threshold, before switching the projector from the second mode to the first mode, the processor is configured to drive the lens module to perform a precise focusing procedure, wherein:
in the precise focusing procedure, the processor obtains the distance signal and determines an adjustment direction and a target step number of the focusing motor according to the obtained distance signal,
when the adjustment direction conforms to a preset direction, the processor generates the focusing signal according to the target step number to control the focusing motor to adjust from a current step number to the target step number,
when the adjustment direction does not conform to the preset direction, the processor generates the focusing signal according to the target step number and a correction step number to control the focusing motor to adjust from the current step number to the correction step number in the adjustment direction, and then to adjust from the correction step number to the target step number in the preset direction, wherein a distance between the correction step number and the current step number is greater than a distance between the target step number and the current step number.

8. The projector as claimed in claim 7, wherein the processor comprises a storage unit configured to store a lookup table, and the processor obtains the target step number according to the distance signal and the lookup table.

9. The projector as claimed in claim 1, wherein when the processor determines to switch the projector from the second mode to the first mode, the processor outputs a termination signal corresponding to the second mode to the ranging unit so as to cause the ranging unit to stop detecting the distance.

10. An autofocus method for a projector, the projector comprising a lens module, the lens module comprising a projection lens and a focusing motor, the projection lens being configured to project an image beam onto a projection surface, the autofocus method comprising the steps of:
continuously detecting a motion state of the projector through an inertial sensor to generate an inertial sensing signal;
in a first mode, comparing the inertial sensing signal with an activation threshold to generate a first comparison result, and determining whether to switch the projector from the first mode to a second mode according to the first comparison result; and
in the second mode, continuously detecting a distance between the projector and the projection surface through a ranging unit to generate a distance signal, continuously outputting the distance signal, and generating a corresponding focusing signal to the focusing motor of the lens module according to the distance signal so as to drive the focusing motor to adjust a focal length of the projection lens.

11. The autofocus method as claimed in claim 10, wherein the step of comparing the inertial sensing signal with the activation threshold to generate the first comparison result in the first mode, and determining whether to switch the projector from the first mode to the second mode according to the first comparison result, comprises:
switching the projector to the second mode when the first comparison result is that the inertial sensing signal is greater than or equal to the activation threshold; and
maintaining the projector in the first mode when the first comparison result is that the inertial sensing signal is less than the activation threshold.

12. The autofocus method as claimed in claim 10, further comprising:
outputting an actuation signal corresponding to the second mode to the ranging unit in the first mode when it is determined, according to the first comparison result, to switch the projector to the second mode so as to cause the ranging unit to continuously generate the distance signal.

13. The autofocus method as claimed in claim 10, further comprising:
in the second mode, comparing the inertial sensing signal with an end threshold to generate a second comparison result, and determining whether to switch the projector from the second mode to the first mode according to the second comparison result, wherein the end threshold is different from the activation threshold.

14. The autofocus method as claimed in claim 13, wherein the end threshold is less than the activation threshold.

15. The autofocus method as claimed in claim 13, wherein the step of comparing the inertial sensing signal with the end threshold to generate the second comparison result in the second mode, and determining whether to switch the projector from the second mode to the first mode according to the second comparison result, comprises:
maintaining the projector in the second mode when the second comparison result is that the inertial sensing signal is greater than the end threshold; and
switching the projector from the second mode to the first mode when the second comparison result is that the inertial sensing signal is less than or equal to the end threshold.

16. The autofocus method as claimed in claim 15, wherein before switching the projector from the second mode to the first mode when the second comparison result is that the inertial sensing signal is less than or equal to the end threshold, a precise focusing procedure is executed, the precise focusing procedure comprising:
obtaining the distance signal and determining an adjustment direction and a target step number of the focusing motor according to the obtained distance signal;
generating the focusing signal according to the target step number to control the focusing motor to adjust from a current step number to the target step number when the adjustment direction conforms to a preset direction; and
generating the focusing signal according to the target step number and a correction step number to control the focusing motor to adjust from the current step number to the correction step number in the adjustment direction, and then to adjust from the correction step number to the target step number in the preset direction when the adjustment direction does not conform to the preset direction, wherein a distance between the correction step number and the current step number is greater than a distance between the target step number and the current step number.

17. The autofocus method as claimed in claim 16, further comprising:
obtaining the target step number according to the distance signal and a lookup table.

18. The autofocus method as claimed in claim 10, further comprising:
outputting a termination signal corresponding to the second mode to the ranging unit when it is determined to switch the projector from the second mode to the first mode so as to cause the ranging unit to stop detecting the distance.
